(19) United States
(12) Patent Application Publication
(10) Pub. No.: US 2024/0246838 A1
(43) Pub. Date: Jul. 25, 2024

(54) METHOD OF OBTAINING THE REQUESTED SALT DOSE BY ADJUSTING THE FILL TIME TO COMPENSATE FOR LACK OF SATURATED BRINE

(71) Applicant: Ecowater System LLC, Woodbury, MN (US)

(72) Inventors: George Dimotsis, Woodbury, MN (US); Jeffrey A. Zimmerman, Crosslake, MN (US)

(21) Appl. No.: 18/420,230

(22) Filed: Jan. 23, 2024

Related U.S. Application Data
(60) Provisional application No. 63/440,796, filed on Jan. 24, 2023.

(51) Int. Cl. C02F 1/42; C02F 1/00

(52) U.S. Cl. CPC C02F 1/42; C02F 1/008; C02F 2209/006; C02F 2209/44; C02F 2303/16

(57) ABSTRACT

A process of analytically determining the adjusted fill time for a brine tank based on non-adjusted fill time and an analytically derived multiplier factor, in order to compensate for brine saturation. Calculating a non-adjusted fill time as a function of actual salt dose requested; determining a multiplier factor (MF) for the non-adjusted fill time utilizing an empirically generated fill time curve; and calculating the fill time as a product of the non-adjusted fill time and the multiplier factor for a given salt dose, such that a water softener system can be provided with extra water to account for a brine concentration lower than 100% saturated brine.

### BACKGROUND OF THE INVENTION

### 1. Field of the Invention

This invention relates to water softeners, and specifically to brine saturation adjustment in water softener operations. More specifically, this invention relates to the analytical determination of adjusted fill time for a brine tank based on non-adjusted fill time and an analytically derived multiplier factor.

### 2. Description of Related Art

Water systems using groundwater as a source are generally concerned with water hardness. As water moves through soil and rock it dissolves small amounts of naturally-occurring minerals and carries them into the groundwater supply. Water is known to be a great solvent for calcium and magnesium, thus if the minerals are present in the soil around a water-supply well, the hard water may be delivered to homes. In this manner, water hardness varies as a function of geography. For example, in areas within the United States where the water is relatively hard, industries might have to spend funds and resources to soften the water, as hard water can damage equipment, fabrics, and clothes.

Calcium and magnesium dissolved in water are the two most common minerals that make water “hard.” The degree of hardness becomes greater as the calcium and magnesium content increases and is related to the concentration of multivalent cations dissolved in the water.

The hardness of water is generally referred to by three types of measurements: grains per gallon, milligrams per liter (mg/L), or parts per million (ppm). General guidelines for classification of waters are typically: 0 to 60 mg/L (milligrams per liter) of calcium carbonate is classified as soft; 61 to 120 mg/L is classified as moderately hard; 121 to 180 mg/L is classified as hard; and more than 180 mg/L is classified as very hard.

Water softening is an ion exchange technique used for removing calcium and magnesium ions that form hard water scale such as calcium and magnesium carbonate. The process involves exchanging source water calcium and magnesium cations for sodium cations that have been adsorbed onto resin beads filled with exchange sites. As water flows through the softener system, sodium ions are released (exchanged) from the resin, and the hard water ions are collected on the exchange sites.

A water softener includes a resin tank that is filled with resin comprising small beads of cross-lined polystyrene sulfonic acid, and is generally referred to as a cation resin. The resin is usually placed into service with Na⁺ ions on the beads. When hardness ions come into contact with the Na⁺ ions bound to the resin, they exchange, or the calcium displaces two Nations, and the Na⁺ ions are released in the water. Typically, two Na⁺ ions are exchanged for every one Ca or Mg ion. In addition, iron in the water also exchanges with sodium and reduces the capacity of the water softener.

Brine is an auxiliary agent in water softening and water purification systems involving ion exchange technology. Generally, brine is a solution of salt and water. The term may refer to concentrations of about 3.5% up to 26%, at which point brine is considered fully saturated. Brine is not involved in the purification process itself, but used for regeneration of ion-exchange resin on a cyclical basis. Typically, when a water softener detects that it is time for a regeneration cycle, it flushes its tank with a mixture of salt and water (brine). Normally, calcium and magnesium have a stronger hold on the resin beads inside of the tank, which is why they are able to replace the sodium ions during the softening process. However, the brine used during a regeneration cycle has such a high concentration of sodium that it overwhelms the calcium and magnesium ions, and those hardness ions are knocked off of the beads and replaced by the sodium ions in the brine. The calcium and magnesium ions are then flushed out of the tank with the remaining water from the brine, and the softener is ready to perform again.

Typically, the water being treated flows through the resin container until the resin is considered exhausted and water is purified to a desired level. Regeneration is achieved by exposing the ion exchange resin to a brine solution. The brine solution is typically held in a brine tank. The brine tank is where a highly concentrated salt solution of sodium or potassium is stored. The brine solution comes into play to flush the mineral tank and recharge it. Generally, the brine tank must be periodically replenished with a salt of sodium or potassium.

The brine concentration is desirably high enough that the resin replaces the hardness ions in the resin with sodium ions. The hardness ions removed from the resin, along with some excess sodium and chloride ions, are sent to a drain. The resin is then regenerated by sequentially backwashing the resin bed to remove accumulated solids, flushing removed ions from the resin with a concentrated solution of replacement ions, and rinsing the flushing solution from the resin. After treatment, ion-exchange resin beads saturated with calcium and magnesium ions from the treated water, are regenerated. The sodium ions from brine replace the calcium and magnesium ions on the beads.

When a softener with new (or regenerated) resin is placed in service, sodium ions adsorbed on the exchange sites within the resin are immediately exchanged with calcium and magnesium cations. This produces soft water with very little residual hardness in the effluent water. The resin bed will continue to exchange its sodium ions with calcium and magnesium to a point where the exchange sites are reduced, and hard water can be detected in the softener output. This is referred to as the “saturation point” and is the point at which regeneration is needed. Cation softener regeneration requires a concentrated solution of sodium chloride (salt water) to be rinsed through the resin bed; this is a physiochemical process that uses relative ion concentrations and physical flow to remove the hard water ions from the resin.

When it is determined that the brine in a water softener system is saturated, the regeneration process is initiated. Typical types of regeneration include demand regeneration and time-initiated regeneration. Demand regeneration requires a control valve to keep track of how much water is being used before starting the regeneration process. This process only begins after a set amount of water has been sent through the water softener. While hard water can contain different levels of contaminants, using demand regeneration ensures that the regeneration process always occurs at a set time, which means that the resin beads should never become too inefficient before they are properly cleaned. If a higher amount of water is used during a given week, the regeneration process may occur more often.

A time-initiated regeneration process begins only after a specific period of time, which means that water use is not taken into account. Even if a user hardly used any water during a set period of time, the regeneration process will continue to occur at the same interval. The control valve is generally outfitted with a clock that initiates the start of the process.

Another type of control uses a computer that watches how much water is used. When enough water has passed through the mineral tank to have depleted the beads of sodium, the computer triggers regeneration.

Yet another type of control uses a mechanical water meter to measure water usage and initiate recharging. The advantage of this system is that no electrical components are required and the mineral tank is only recharged when necessary.

One softener regeneration process utilizes a “fill first” method, where the first step of the regeneration process is to add a measured amount of water to the brine tank to dissolve a specific amount of salt, determined on estimated water use data, to create enough capacity in the softener to provide soft water for approximately the next few days of operation, and preferably approximately four days of operation. This methodology is predicated on the assumption that the dissolution of salt is very rapid and saturated salt solution is readily available immediately after this fill step. Brine solution is typically then withdrawn using a nozzle and venturi to produce a diluted regeneration stream that is directed through the resin bed for regeneration.

However, it has been shown that the dissolution rate of the salt is usually slower than expected, and thus the softeners are underdosed utilizing this standard process. This deficiency is especially pronounced in smaller softeners where the volumes are lower and the regeneration times are shorter (shorter times lead to lower saturation).

### SUMMARY OF THE INVENTION

Bearing in mind the problems and deficiencies of the prior art, it is therefore an object of the present invention to provide a method of obtaining the requested salt dose by adjusting the fill time to compensate for lack of saturated brine.

It is another object of the present invention to provide a method of compensating for brine saturation for a water softener by determining an adjusted fill time for a brine tank, comprising: a) calculating a non-adjusted fill time as a function of actual salt dose requested; b) empirically deriving a real saturation curve for a predetermined aspirator with a predetermined fill flow rate and draw flow rate; c) determining a multiplier factor (MF) for the non-adjusted fill time utilizing an empirically generated fill time curve; d) calculating the fill time as a product of the non-adjusted fill time and the multiplier factor for a given salt dose; and e) adding water to the brine tank based on an adjusted fill time.

The method further includes empirically deriving the non-adjusted fill time and assigning a formula to represent the non-adjusted fill time as a function of the actual salt dose requested.

The formula of the non-adjusted fill time is derived from a curve-fit function of test data of the non-adjusted fill time as a function of the actual salt dose requested.

The formula of the non-adjusted fill time as a function of the actual salt dose requested is represented by the expression: Fill Time (seconds)=Salt Dose lbs/2.9865 lbs salt/gal/fill rate(gpm)*60 sec/min.

It is yet another object of the present invention to provide a method of compensating for brine saturation for a water softener by determining an adjusted fill time for a brine tank, where the method comprises: a) calculating a non-adjusted fill time as a function of actual salt dose requested; b) determining a multiplier factor (MF) for the non-adjusted fill time utilizing an empirically generated fill time curve; c) adjusting the fill time as a product of the non-adjusted fill time and the multiplier factor for a predetermined salt dose; and d) adding more water to said brine tank by adjusting said fill time.

The method further includes empirically deriving a real saturation curve for a predetermined aspirator with a predetermined fill flow rate and draw flow rate.

The method includes adjusting a pump for a predetermined fill flow rate and preserving a first adjustment position; performing a reverse direction flow and setting a draw rate, and preserving a second adjustment position; introducing a brine tank containing salt and adding water to the brine tank above a brine valve position; and allowing enough time for the brine to saturate.

The pump is then a) momentarily turned OFF and the flow is set to a predetermined draw rate; turned back ON in a reverse direction; and c) the flow is captured for a measured draw time and an average salt concentration.

Test results are then compared to theoretical calculated results, and a polynomial curve of data of the test results is derived.

In another embodiment, the present invention is directed to a water softener capable of compensating for brine saturation, comprising: a brine tank; a resin tank; a pump and valve system; a controller; the softener is configured to determine an adjusted fill time for a brine tank, wherein the controller includes a computer readable storage medium having data stored therein representing software executable by the controller, the software including instructions, preloaded with a predetermined multiplier curve, to: a) determine a specific multiplier factor (MF) based on the predetermined multiplier curve for the non-adjusted fill time utilizing an empirically generated fill time curve; and b) calculate the fill time as a product of the non-adjusted fill time and the multiplier factor for a given salt dose; such that the water softener system is provided with extra water to account for a brine concentration lower than 100% saturated brine.

Still other objects and advantages of the invention will in part be obvious and will in part be apparent from the specification.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a graph depicting capacity as a function of brine concentration through a resin bed;

FIG. 2 is a graph depicting capacity reduction due to 100% saturated brine;

FIG. 3 is a graph depicting requested versus actual salt dose retrieved;

FIG. 4 is a graph depicting an analytical expression for fill time versus actual salt dose requested;

FIG. 5 is graph depicting a multiplier factor versus actual salt dose requested;

FIG. 6 depicts a table of the test parameters for Test Run A;

FIG. 7 depicts a table of the Test Run A results utilizing the parameters of FIG. 6, using experimentally determined data (denoted by **) and measured data (denoted by \hat{ });

FIG. 8 depicts a graph of the actual salt dose (lbs) for a given fill time (seconds) for the test data of Test Run A;

FIG. 9 is a table representing the calculated fill time to obtain the requested salt dose for each test point of Test Run A, along with the associated multiplier factors;

FIG. 10 depicts a table showing the experimental data and the actual salt dose versus the percentage of brine achieved for Test Run B;

FIG. 11 graphs the results of the data table of FIG. 10, and presents a curve-fitting polynomial expression for the percent of brine achieved as a function of salt dose (lbs);

FIG. 12 depicts the sodium chloride brine data table at 60° F.(15.5° C.) for Test Run B;

FIG. 13 graphs the results of FIG. 12, yielding a polynomial curve fit for the salt (lb)/gal water as a function of the percent of sodium chloride;

FIG. 14 depicts a table of the data for the calculated fill of Test Run B;

FIG. 15 graphs the tabulated results of FIG. 14, depicting the gallons of fill rate as a function of salt dose (lbs);

FIG. 16 is a tabulation of the data representing percent of adjusted saturation, depicting the multiplier factor as a function of salt dose;

FIG. 17 graphs the multiplier factor data of FIG. 16 as a function of salt dose; and

FIG. 18 depicts the adjusted fill time as a function of salt dose based on the data of FIGS. 16 and 17.

### DESCRIPTION OF THE PREFERRED EMBODIMENT(S)

In describing the preferred embodiment of the present invention, reference will be made herein to FIGS. 1-18 of the drawings in which like numerals refer to like features of the invention.

It has been determined, and it is desirable, that extra water be added depending upon the actual salt dose and fill flow rate used to obtain the desired amount of salt at a somewhat lower than expected concentration. To perform this method, process modifications are implemented in a control algorithm, which is generally operational via a software package.

Previous software packages assumed that brine being withdrawn from the brine tank was highly saturated, on the order of 100% saturation. However, recent test results of brine concentration found that the concentration is not always near 100% saturated. In this manner, it becomes necessary to find a way to compensate for the less than saturated brine that is pulled from the brine tank into the resin tank.

In a fill-first system, when a regeneration is started, a control valve first advances to the fill position. As fill water enters the brine tank, NaCl begins to dissolve into the water. If the water were to remain indefinitely, eventually it will become fully saturated. Notably, in fill-first systems, after all the fill water enters the brine tank, operating valves do not have a pause position to allow the brine to become fully saturated. After filling, the operating valve advances immediately to the brine draw position. Once in the brine draw position, the brine is pumped or pulled out of the brine tank and then through the softener. The amount of NaCl saturation will vary depending on the duration of the fill cycle and how fast the fill water flows into the brine tank. The shorter the fill duration, the lower the saturation of brine. For small softener systems, the salt doses are small and the brine concentration being pulled from the brine tank can typically be between 75% to 95% of fully concentrated brine.

Although it would be preferred that the brine concentration pulled from the brine tank be 100% saturated, it is more important that the actual requested salt dose be drawn from the brine tank. By pulling the correct salt dose from the brine tank (even though the brine concentration may be lower as it is passed through the resin bed of the softener), the capacity obtained from the correct salt dose is much closer to the expected capacity than if the softener assumed 100% saturated brine.

FIG. 1 depicts a graph showing the brine concentration as having some impact on softener capacity. The percent of maximum capacity 10 on the ordinate axis is presented as a function 12 of percent of NaCl concentration 14 (abscissa) in the bed. As shown, from a concentration of 6% to 16%, the final capacity of the softener can vary by about 3% from the peak at a 100% brine concentration. A typical venturi aspirated system has about 35% of the concentrated brine solution in it. A 100% concentrated brine (26.4% of NaCl in solution) can be mixed with the aspirated water to form a concentration mixture of about 9.2%. Thus, if a 75% concentrated brine coming from the brine tank is mixed by an aspirator, a concentrated mixture of 6.9% will result. In this scenario, the net capacity adjustment is only a drop of about 2.5%.

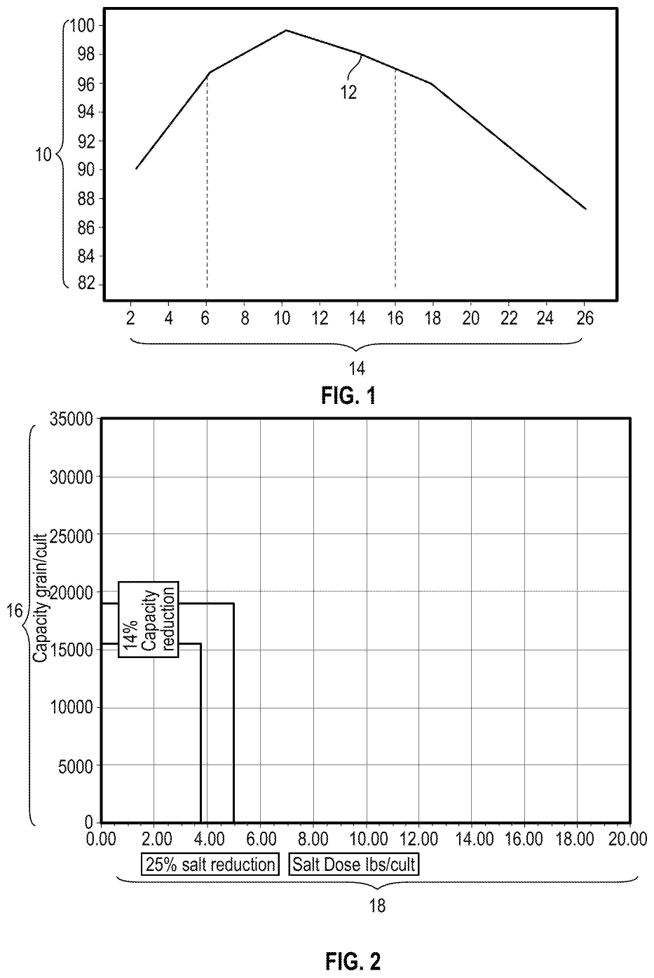

FIG. 2 depicts a 12% to 14% obtainable capacity reduction if the software were to assume 100% saturated brine for a salt dose that was lower by 25%. That is, the capacity reduction due to the lack of a 100% saturated brine condition. It has been determined that one preferrable outcome requires taking a 3% reduction in capacity due to a lower brine concentration with the correct salt dose, rather than to assume 100% saturated brine when in fact the brine is not at that level of saturation. In FIG. 2, the capacity 16 is presented in grains per cubic foot, and the salt dose 18 is presented in pounds per cubic foot.

Typically, laboratory testing determines the brine saturation levels for a given amount of fill water and fill load time. In a preferred embodiment, specific aspirator parameters are taken into account in determining the adjusted fill time. Such parameters include, but are not limited to, fill flow rate and draw flow rate. The adjusted fill time is empirically derived for each given aspirator in the form of an analytical expression of fill time as a function of salt dose.

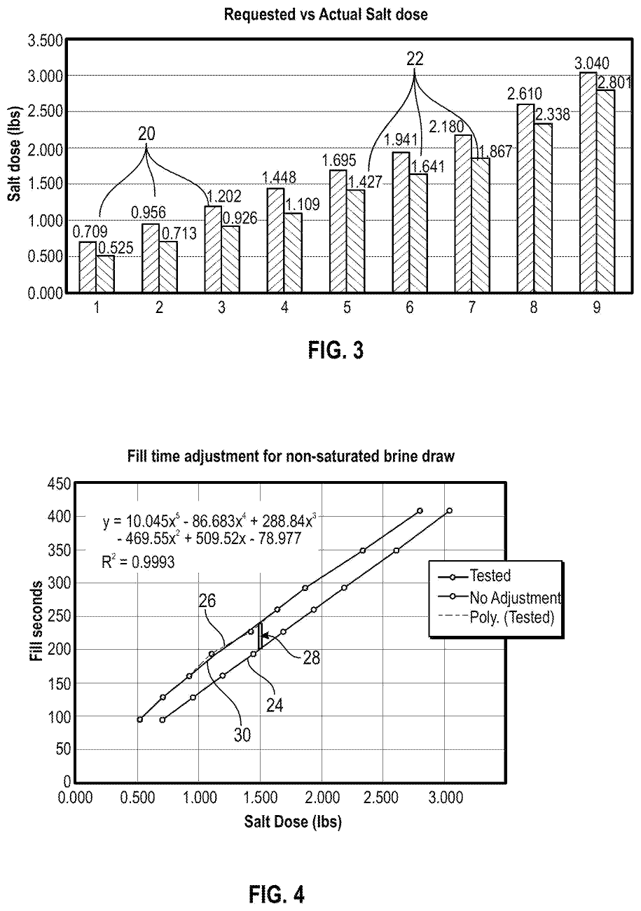

FIG. 3 depicts a bar graph of the requested salt dose 20 (left bar) versus the actual salt dose 22 (right bar). As shown in FIG. 3, the assumed 100% brine saturation point in pounds of NaCl does not match with the actual tested pounds of NaCl removed from the brine tank.

To obtain the correct salt dose, additional fill water must be added to the brine tank before the required amount of salt can be withdrawn. In order to determine the correct amount of additional fill water to add, an analytical expression is calculated from data fitted to empirical results. For example, referring to FIG. 4, a formula derived from the test data can be used to represent the correct fill time needed to achieve a given salt dose request.

As an illustrious example, for a given tested aspirator, the tested fill time curve for non-saturated brine draw can be determined by a curve-fitting algorithm, resulting in an analytical expression, which is derived from empirical results. In the present example:

$$Fill Time ( seconds ) = 10.045 {x}^{5} - 86.683 {x}^{4} + 288.84 {x}^{3} - 469.55 {x}^{2} + 509.52 x - 78.977$$

where, x is the salt dose requested (lbs)

From the above curve-fit formula, one is able to ascertain the difference of the requested assumed 100% brine concentration fill time 24 to the actual fill time 26 that provides the correct salt dose. A curve 30 of the aforementioned polynomial is shown in dotted line, and closely matches the actual fill time 26. A multiplier factor can then be calculated for any given point along the curve. As depicted in FIG. 4, the ratio 28 from the non-adjusted curve to the tested curve graphically identifies the multiplier factor. The ratio 28 is presented at a 1.5 lbs salt dose on the graph. The ratio 28 depicted at 1.5 lbs salt dose is the difference of fill seconds from 200 to about 240, which corresponds to a multiplier factor of about 1.2 (200 fill seconds×1.2=240 fill seconds).

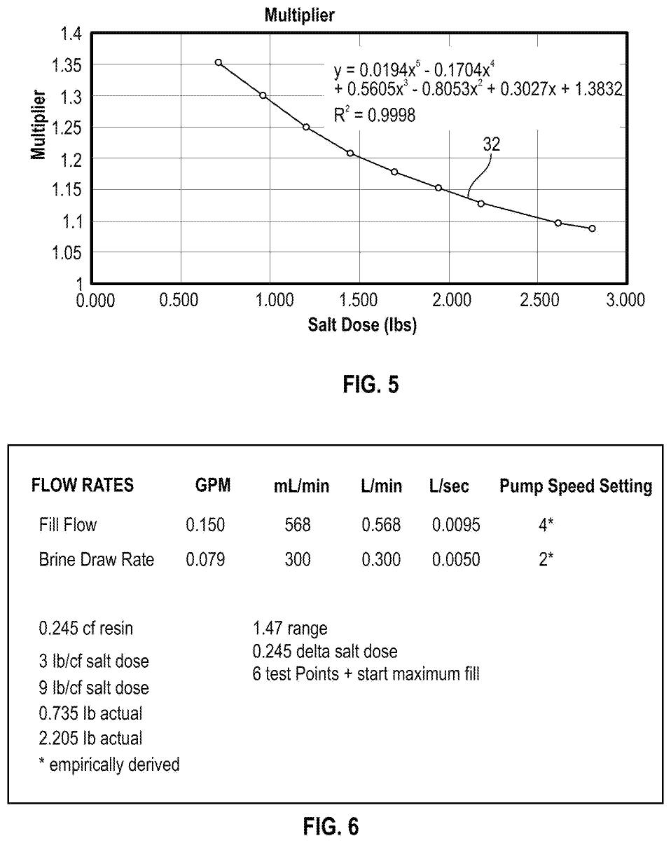

Calculating the multiplier factor for each salt dose presented and graphing the multiplier factor as a function of salt dose (lbs) yields the multiplier factor curve 32 depicted in FIG. 5. As depicted in this curve, a multiplier formula can be obtained to calculate the additional fill time needed above and beyond the original assumed 100% brine saturated fill time. Shown in FIG. 5 is associated multiplier analytical expression that can be used for any given salt dose requested within the range to ultimately provide the correct fill time to use.

In this illustrious example, a curve-fitting algorithm identifies the analytical expression for the multiplier factor (MF) as:

$$MF = 0.0194 {x}^{5} - 0.1704 {x}^{4} + 0.56 {x}^{3} - 0.8053 {x}^{2} + 0.3027 x + 1.3832$$

where, x is the salt dose requested (lbs)

Thus, the following parameters are utilized in the calculation of adjusted fill time: a) fill flow rate; b) requested salt dose; c) 100% saturated brine fill time formula; d) multiplier formula; and e) the calculation of the 100% saturated fill time with the multiplier factor.

As noted above, after data is collected, it is used to create the multiplier factor curve for a given salt dose/fill rate, and for a given aspirator draw rate, to compensate for inadequately saturated brine.

### Example: Adjusted Fill Time for 1.5 Pound Salt Dose

In order to determine the fill time required if the brine saturation was at 100%, the constant 2.9865 is utilized to represent is how much salt dissolves into 1 gallon of water at 60° F. The fill flow rate is a parameter of the tested system. If the fill flow rate is changed, then the analytical testing would have to be redone for that particular flow rate, and new formulas would be created for that system. The formula is then implemented into the software for a specific fill flow rate and aspirator draw rate.

Assuming a salt dose of 1.5 lbs of NaCl is requested, and a fill flow rate of 0.15 gpm, utilizing the 100% saturated brine formula, the non-adjusted fill time seconds or 100% assumed saturated brine (fill time seconds) is identified by units as: (Salt dose lbs)/(lbs of NaCl dissolve in 1 gallon of water)/(fill flow gpm), which may be generally represented as:

$$Fill Time ( seconds ) = Salt Dose lbs / 2.9865 lbs salt / gal / fill rate ( gpm ) * 60 sec / min$$

And numerically represented as:

$$= 1.5 lbs / 2.9865 lbs of salt / gal / 0.15 gpm * 60 secs / min$$

$$= 201 seconds ( 100 \% saturated brine formula fill time )$$

Calculating the multiplier formula (MF) for 1.5 lbs using the aforementioned analytical expression:

$$MF = ( 0.00194 ) {( 1.5 )}^{5} - ( 0.1704 ) {( 1.5 )}^{4} + ( 0.5605 ) {( 1.5 )}^{3} - ( 0.8053 ) {( 1.5 )}^{2} + ( 0.3027 ) ( 1.5 ) + 1.3832 = 1.2$$

Finalizing the calculations for an adjusted fill time using the fill time of the 100% saturated brine formula (201 seconds) and the multiplier formula (1.2) yields:

$$Adjusted Fill Time = 201 seconds * 1.2 = 241 seconds$$

The process described above, to determine an adjusted fill time, can be summarized in the process steps as follows: a) calculating a non-adjusted fill time as a function of the actual salt dose requested; b) determining a multiplier factor for the non-adjusted fill time utilizing an empirically generated fill time curve; and c) adjusting the fill time as a product of the non-adjusted fill time and the multiplier factor for a given salt dose.

### Test Run A

The process steps for performing the novel method of obtaining the requested salt dose by adjusting the fill time to compensate for lack of saturated brine begins with the fill flow rate. First, an adjustment is made to the pump for the predetermined fill flow rate, and the dial position is preserved. Next, the user performs a reverse direction of flow, and sets the draw rate, again marking the dial position. The brine tank is filled with salt. Water is added to a level above the brine valve, the pump is utilized to remove the water to the level of the brine valve cut off.

The system remains unaltered long enough to generate saturated brine in the bottom layer. This period can take 1 to 4 hours, preferably about 3 hours. Using the actual brine tank and line, water is pumped into the brine for the fill time at the fill flow rate. The pump is turned off momentarily, and the flow set to the draw rate. The pump is turned on in the reverse direction. All the flow is captured for the measured draw time and stirred. The weight of the Brine drawn is measured, along with the average salt concentration (in percentage) with a refractometer. FIG. 6 depicts a table of the test parameters for Test Run A.

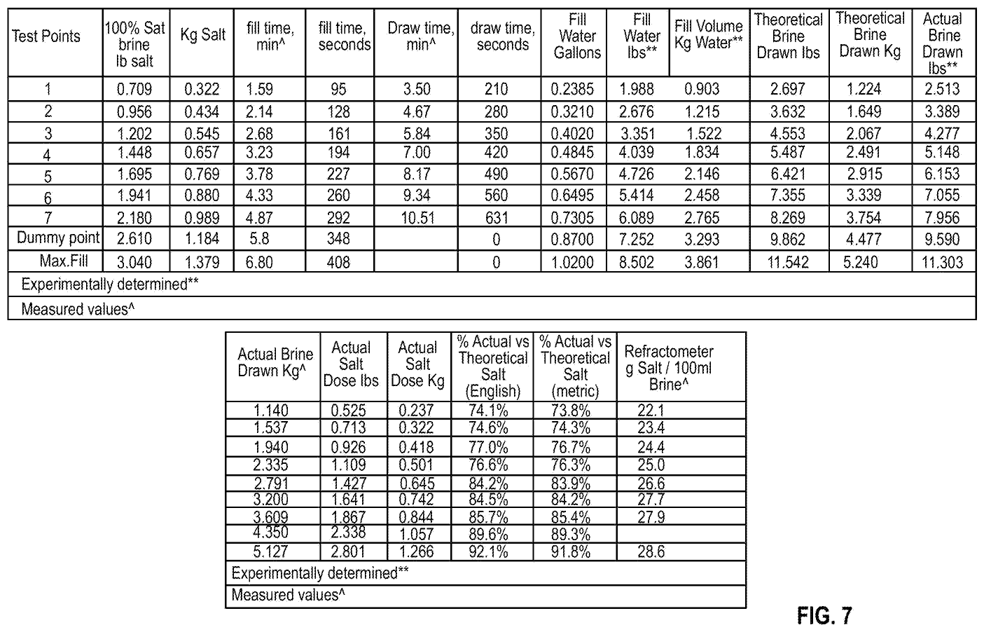

FIG. 7 depicts a table of the Test Run A results, using experimentally determined data (denoted by **) and measured data (denoted by \hat{ }). Measured and experimentally determined values are compared to theoretical values and percentages of actual versus theoretical values are presented.

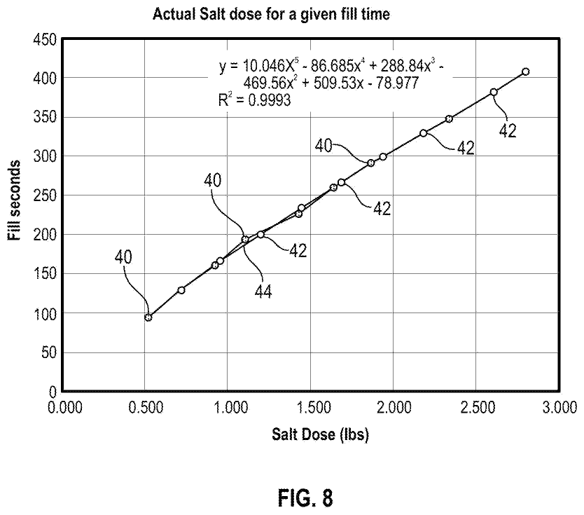

FIG. 8 depicts a graph of the actual salt dose (lbs) for a given fill time (seconds) for the test data of Test Run A. Test data results 40 are compared to the theoretical calculated results 42, and the polynomial curve 44 from a curve fitting algorithm of the test data results (dotted line) closely follows the test data results line. As can be seen, the polynomial curve fit represents the results depicted in FIG. 4.

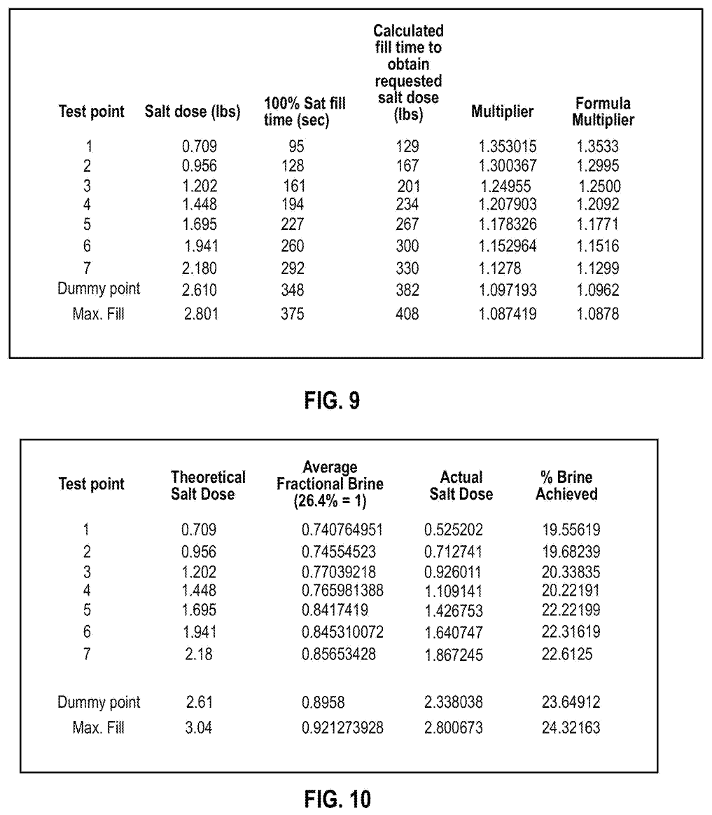

FIG. 9 is a table representing the calculated fill time to obtain the requested salt dose for each test point of Test Run A, along with the associated multiplier factors. These results provide the data points for the multiplier curve 32 in the graph of FIG. 5. Sample extrapolation points (dummy points) may be added by the user in instances to ensure continuous curve-fitting analytics to be more representative of the data.

### Test Run B

As an indicator of the efficiency of the application of Test Run A's methodology, in this example, the application of the lab test data of Test Run A is applied in a altered method by measuring the brine saturation as a function of time, and attempting to calculate the extra quantity of water to add to the system, based on the known concentration. However, due to the extra time to add the extra water, there is a chance for further saturation. Thus, there remains a risk of extracting too much salt in the process.

First, the curve for actual salt dose is created for a given fill time. Next, that curve is used to generate a fill time for a request salt dose. The 100% salt brine fill time is then calculated from the requested salt dose. Using the original 100% saturated fill time and the calculated fill time, the actual salt dose requested is obtained. From these values, the multiplier factor is determined. This methodology is performed for a plurality of requested salt doses, and the data is charted (and curve-fit) to provide a polynomial expression showing the multiplier factor for the expected 100% saturated fill time for a given requested salt dose.

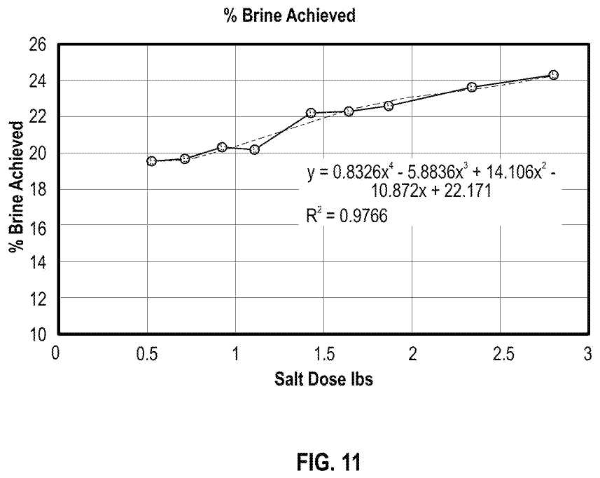

Experiments were conducted using a set-up having a 0.15 gpm fill flow plug, a 0.22 brine flow plug, and a 0.46 venturi nozzle disc. FIG. 10 depicts a table showing the experimental data and the actual salt dose versus the percentage of brine achieved for Test Run B. FIG. 11 graphs the results of the data table of FIG. 10, and presents a curve-fitting polynomial expression for the percent of brine achieved as a function of salt dose (lbs).

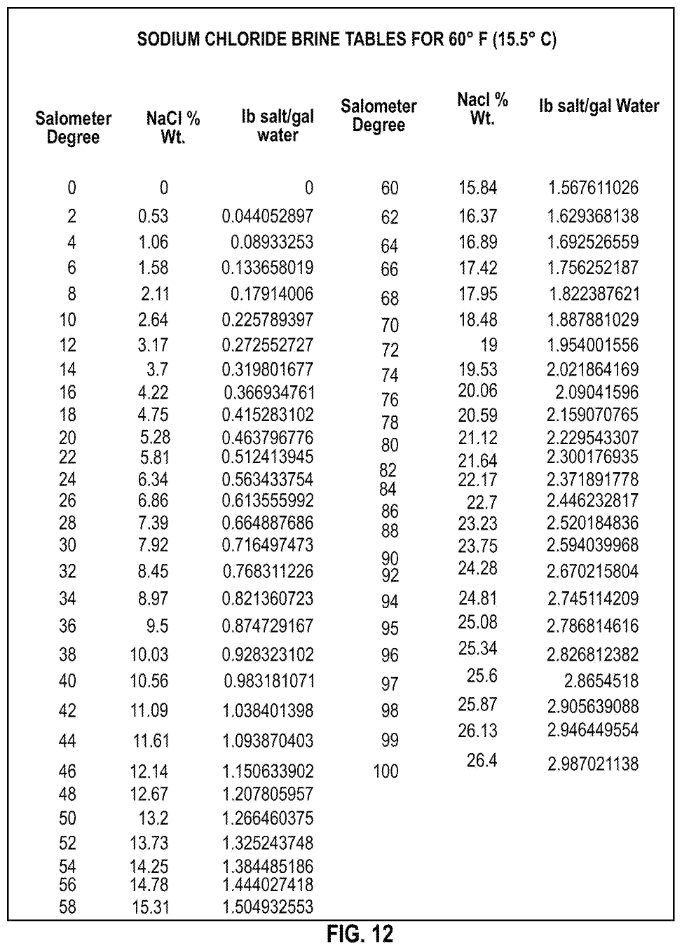

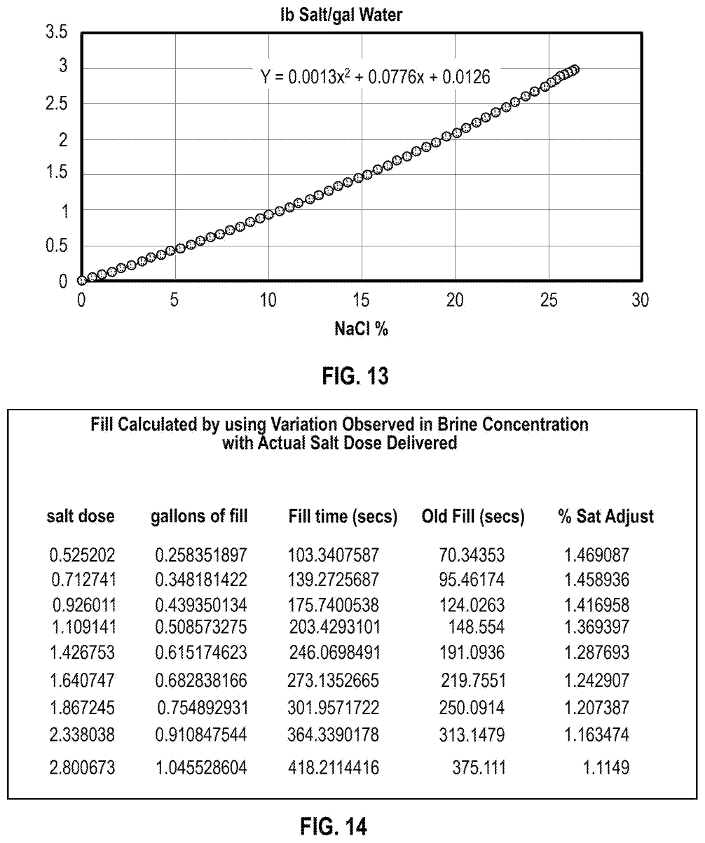

FIG. 12 depicts the sodium chloride brine table at 60° F. (15.5° C.) for Test Run B. FIG. 13 graphs the results of FIG. 12, yielding a polynomial curve fit for the salt (lb)/gal water as a function of the percent of sodium chloride. The fill is calculated by utilizing the variation observed in the brine concentration against the actual salt dose delivered. FIG. 14 depicts a table of the data for the calculated fill of Test Run B.

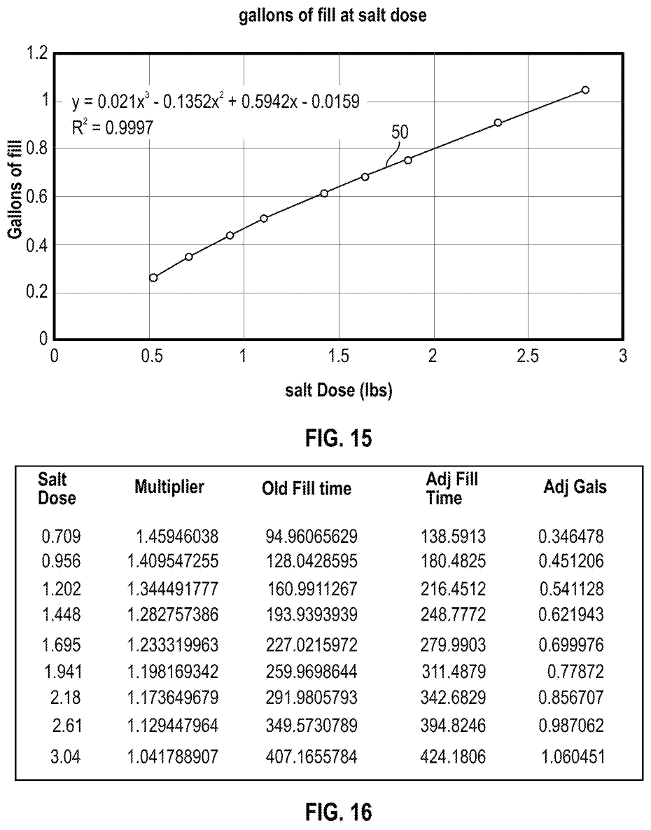

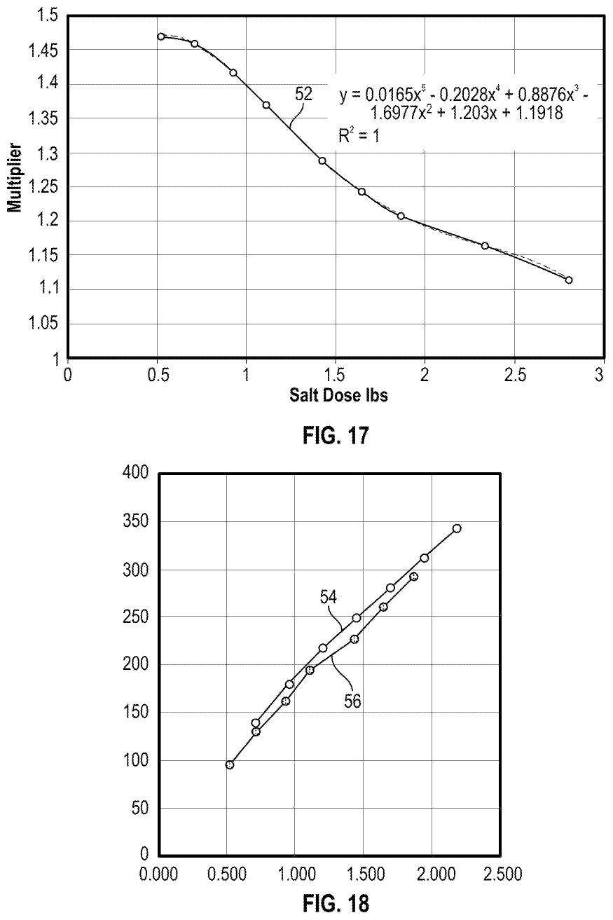

FIG. 15 graphs the tabulated results of FIG. 14, depicting the gallons of fill rate as a function of salt dose (lbs), and provides a polynomial curve fit 50 that analytically models the results. FIG. 16 is a tabulation of the data representing the percent of adjusted saturation, depicting the multiplier factor as a function of salt dose. FIG. 17 graphs the multiplier factor data of FIG. 16 as a function of salt dose (lbs). Curve 52 represents the polynomial curve fit of the multiplier factor data.

FIG. 18 depicts the adjusted fill time as a function of salt dose based on the data of FIGS. 16 and 17. The formulated data is shown as curve 54 and the tested data is represented in curve 56.

In another embodiment, a water softener is presented that is capable of compensating for brine saturation using the methodology identified above. The water softener includes a brine tank, a resin tank, a pump and valve system, and a controller having a computer readable storage medium having data stored therein representing software executable by the controller, the softener is configured to determine an adjusted fill time for a brine tank, wherein the controller includes a computer readable storage medium having data stored therein representing software executable by the controller, the software including instructions, preloaded with a predetermined multiplier curve, to: a) determine a specific multiplier factor (MF) based on the predetermined multiplier curve for the non-adjusted fill time utilizing an empirically generated fill time curve; and b) calculate the fill time as a product of the non-adjusted fill time and the multiplier factor for a given salt dose; such that the water softener system is provided with extra water to account for a brine concentration lower than 100% saturated brine.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of compensating for brine saturation for a water softener by determining an adjusted fill time for a brine tank, comprising:
a) calculating a non-adjusted fill time as a function of actual salt dose requested;
b) empirically deriving a real saturation curve for a predetermined aspirator with a predetermined fill flow rate and draw flow rate;
c) determining a multiplier factor (MF) for the non-adjusted fill time utilizing an empirically generated fill time curve;
d) calculating the fill time as a product of the non-adjusted fill time and the multiplier factor for a given salt dose; and
e) adding water to said brine tank based on an adjusted fill time.

2. The method of claim 1 wherein said step of calculating said non-adjusted fill time as a function of said actual salt dose requested is performed by empirically deriving said non-adjusted fill time and assigning a formula to represent said non-adjusted fill time as a function of said actual salt dose requested.

3. The method of claim 2 wherein said formula of said non-adjusted fill time is derived from a curve-fit function of test data of said non-adjusted fill time as a function of said actual salt dose requested.

4. The method of claim 3 wherein said formula of said non-adjusted fill time as a function of said actual salt dose requested is represented by the expression:
Fill Time (seconds)=Salt Dose lbs/2.9865 lbs salt/gal/fill rate(gpm)*60 sec/min.

5. The method of claim 1 wherein said step of determining said multiplier factor (MF) for the non-adjusted fill time is derived from a curve-fit function of said empirically generated fill time curve against said non-adjusted fill time.

6. The method of claim 5 wherein said step of determining said multiplier factor (MF) for the non-adjusted fill time utilizing said empirically generated fill time curve where the MF is represented as a function of the salt dose requested (lbs).

7. A method of compensating for brine saturation for a water softener by determining an adjusted fill time for a brine tank, said method comprising:
a) calculating a non-adjusted fill time as a function of actual salt dose requested;
b) determining a multiplier factor (MF) for the non-adjusted fill time utilizing an empirically generated fill time curve;
c) adjusting the fill time as a product of the non-adjusted fill time and the multiplier factor for a predetermined salt dose; and
d) adding more water to said brine tank by adjusting said fill time.

8. The method of claim 7 including empirically deriving a real saturation curve for a predetermined aspirator with a predetermined fill flow rate and draw flow rate.

9. The method of claim 7 including adjusting a pump for a predetermined fill flow rate and preserving a first adjustment position.

10. The method of claim 9 including performing a reverse direction flow and setting a draw rate, and preserving a second adjustment position.

11. The method of claim 10 including introducing a brine tank containing salt and adding water to said brine tank, if necessary, above a brine valve position.

12. The method of claim 9 including:
a) turning OFF said pump momentarily and setting the flow to a predetermined draw rate;
b) turning said pump back ON in a reverse direction; and
c) capturing said flow for a measured draw time, and an average salt concentration.

13. The method of claim 12 including comparing test results to theoretical calculated results, and deriving a polynomial curve of data of said test results.

14. The method of claim 13 including calculating fill time to obtain the requested salt dose for each test point, along with associated multiplier factors for each of said test points.

15. A water softener capable of compensating for brine saturation, comprising:
a brine tank;
a resin tank;
a pump and valve system;
a controller;
said softener is configured to determine an adjusted fill time for a brine tank, wherein said controller includes a computer readable storage medium having data stored therein representing software executable by said controller, the software including instructions preloaded with a predetermined multiplier curve, said instructions to:
a) determine a specific multiplier factor (MF) based on the predetermined multiplier curve for the non-adjusted fill time utilizing an empirically generated fill time curve; and
b) calculate the fill time as a product of the non-adjusted fill time and the multiplier factor for a given salt dose;
such that the water softener system is provided with extra water to account for a brine concentration lower than 100% saturated brine.
